(19) United States
(12) Patent Application Publication
(10) Pub. No.: US 2005/0180325 A1
(43) Pub. Date: Aug. 18, 2005

(54) Method of controlling data transmission, radio system, packet control unit, and remote network element

(75) Inventors: Kari Niemela, Oulu (FI); Mika Forssell, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/043,934

(22) Filed: Jan. 28, 2005

Related U.S. Application Data
(63) Continuation of application No. 10/830,433, filed on Apr. 23, 2004.

(30) Foreign Application Priority Data
Feb. 13, 2004 (FI) 20040232

(51) Int. Cl. H04L 1/00

(52) U.S. Cl. 370/230; 370/310

(57) ABSTRACT

There is provided a radio system comprising a remote network element, a packet control unit and a mobile station, the radio system being configured to communicate control blocks and data blocks between the mobile station, the packet control unit and the remote network element, the control blocks controlling data transmission in the radio system. The packet control unit is configured to determine which given packet control unit functionalities related to the transmission of given control or data blocks are to be distributed from the packet control unit to a remote net-work element, and to provide to the remote network element control information on which packet control unit functionalities are distributed to the remote network element; and the remote network element is configured to perform the given packet control unit functionalities for given control blocks or data blocks on the basis of the control information received from the packet control unit.

### BACKGROUND OF THE INVENTION

1. Field of the Invention

The invention relates to a method of controlling data transmission in a radio system, to a radio system, to a packet control unit, to a remote network element, to a base transceiver station and to a base station controller.

2. Description of the Related Art

In known radio systems, a packet control unit may control the communication between mobile stations and the radio system over radio interface. The packet control unit uses an RLC (radio link control)/MAC (medium access control) protocol in the communication between the mobile stations and the network. When the packet control unit is located apart from a base station, the RLC/MAC retransmissions and uplink sending permission assignments, for example, are not working so optimally as possible because the interface used between the base station and the packet control unit adds delay into the operation.

An RLC roundtrip delay, for example, is an important measure of (E)GPRS (Enhanced General Packet Radio Service) end-to-end performance, and it should be optimised by any means. One method to reduce the roundtrip delay is “local packet control unit architecture” where the packet control unit is located in the base station. However, the delays in the “local packet control unit architecture” are minimised and limited mainly by available processing power.

Delays of data transfer in (E)GPRS based networks may be too high for delay sensitive applications like VolP (Voice over IP) and streaming in poor radio conditions. GPRS specifications have been improved by delaying the temporary block flow release allowing the data transfer to continue without the re-establishment of a Temporary Block Flow after a short pause on data flow. However, some situations, such as RLC (Radio Link Control) data block retransmission and sending permission assignments to the mobile stations in uplink direction, increase delays and may cause wasting all uplink radio transmitter permissions to some mobile stations.

### SUMMARY OF THE INVENTION

An object of the invention is to provide an improved method of con-trolling data transmission in a radio system, an improved radio system, an improved packet control unit and an improved remote network element. According to an aspect of the invention, there is provided a method of controlling data transmission in a radio system. The method comprising: communicating control blocks and data blocks between a mobile station, a packet control unit and a remote network element, the control blocks controlling data transmission; determining, by the packet control unit, which given packet control unit functionalities related to the transmission of given control or data blocks are to be distributed from the packet control unit to a remote network element; providing to the remote network element, by the packet control unit, control information on which packet control unit functionalities are distributed to the remote network element; and performing, by the remote network element, the packet control unit functionalities for given control or data blocks on the basis of the control information received from the packet control unit.

According to another aspect of the invention, there is provided a method of controlling data transmission in a radio system. The method com-prising: communicating control blocks and data blocks between a mobile station and a packet control unit via a remote network element, the control blocks controlling data transmission and comprising uplink positive acknowledgement or negative acknowledgement messages; determining which given packet control unit functionalities related to the transmission of given control or data blocks are to be distributed from the packet control unit to a remote network element; and generating or manipulating, by the remote network element, the uplink positive acknowledgement or negative acknowledgement messages on the basis of the determination.

According to another aspect of the invention, there is provided a method of controlling data transmission in a radio system. The method com-prising: communicating control blocks and data blocks between a mobile station, a packet control unit and a remote network element, the control blocks controlling data transmission and comprising downlink positive acknowledgement or negative acknowledgement messages; determining which given packet control unit functionalities related to the transmission of given control or data blocks are to be distributed from the packet control unit to a remote network element; and decoding, by the remote network element, the downlink acknowledgement messages received from the mobile station, and retransmitting negative acknowledged data blocks, on the basis of the determination.

According to another aspect of the invention, there is provided a radio system comprising a remote network element, a packet control unit and a mobile station, the radio system being configured to communicate control blocks and data blocks between the mobile station, the packet control unit and the remote network element, the control blocks controlling data transmission in the radio system. The packet control unit is configured to determine which given packet control unit functionalities related to the transmission of given control or data blocks are to be distributed from the packet control unit to a re-mote network element, and to provide to the remote network element control information on which packet control unit functionalities are distributed to the remote network element; and the remote network element is configured to perform the given packet control unit functionalities for given control blocks or data blocks on the basis of the control information received from the packet control unit.

According to another aspect of the invention, there is provided a radio system comprising a remote network element, a packet control unit and a mobile station, the radio system being configured to communicate control and data blocks between the mobile station, the packet control unit and the remote network element, the control blocks and data blocks controlling data transmission and comprising uplink positive acknowledgement or negative acknowledgement messages. The packet control unit or a remote network element is configured to determine which given packet control unit functionalities related to the transmission of given control data blocks are to be distributed from the packet control unit to the remote network element, and the remote network element is configured to generate or manipulate the uplink positive acknowledgement or negative acknowledgement messages on the basis of the determination by the packet control unit or by the remote network element.

According to another aspect of the invention, there is provided a radio system comprising a remote network element, a packet control unit and a mobile station, the radio system being configured to communicate control blocks and data blocks between the mobile station, the packet control unit and the remote network element, the control blocks and data blocks controlling data transmission and comprising downlink positive acknowledgement or negative acknowledgement messages. The packet control unit or a remote network element is configured to determine which given packet control unit functionalities related to the transmission of given control data blocks are to be distributed from the packet control unit to the remote network element; and the remote network element is configured to decode the downlink acknowledgement messages received from the mobile station, and to retransmit negative acknowledgement messages, on the basis of the determination by the packet control unit or by the remote network element.

According to another aspect of the invention, there is provided a packet control unit of a radio system, the packet control unit comprising one or more communication units for communicating control blocks and data blocks with a remote network element, and a control unit for controlling the functions of the packet control unit. The control unit is further configured to determine which given packet control unit functionalities related to the transmission of given control blocks or data blocks are to be distributed from packet control unit to the remote network element; and the communication unit is configured to provide to the remote network element control information on which packet control unit functionalities are distributed to the remote network element.

According to another aspect of the invention, there is provided a remote network element of a radio system, the remote network element com-prising one or more transceivers for communicating control blocks and data blocks with a packet control unit and a mobile station, and a control unit for controlling the functions of the remote network element. The transceiver is further configured to receive from the packet control unit control information on which given packet control unit functionalities are distributed to the remote network element; and the control unit is configured to perform the packet control unit functionalities for given control blocks or data blocks based on the control information received from the packet control unit.

According to another aspect of the invention, there is provided a base transceiver station of a radio system, the base transceiver station comprising one or more transceivers for communicating control blocks and data blocks with a packet control unit and a mobile station, and a control unit for controlling the functions of the base transceiver station. The transceiver is further configured to receive from the packet control unit control information on which given packet control unit functionalities are distributed to the base transceiver station; and the control unit is configured to perform the packet control unit functionalities for given control blocks or data blocks based on the control information received from the packet control unit.

According to another aspect of the invention, there is provided a base station controller of a radio system, the base station controller com-prising one or more transceivers for communicating control blocks and data blocks with a packet control unit and a mobile station, and a control unit for controlling the functions of the base station controller. The transceiver is further configured to receive from the packet control unit control information on which given packet control unit functionalities are distributed to the base station controller; and the control unit is configured to perform the packet control unit functionalities for given control blocks or data blocks based on the control information received from the packet control unit.

According to another aspect of the invention, there is provided a radio system comprising a remote network element, a packet control unit and a mobile station, the remote network element comprising means for communicating control blocks and data blocks with the packet control unit and the mobile station, the control blocks controlling data transmission in the radio system. The packet control unit comprising means for determining which given packet control unit functionalities related to the transmission of given control blocks or data blocks are to be distributed from the packet control unit to the remote network element, and for providing to the remote network element control in-formation on which packet control unit functionalities are distributed to the re-mote network element; and the remote network element further comprising means for performing the packet control unit functionalities for given control blocks or data blocks on the basis of the control information received from the packet control unit.

The embodiments of the invention provide several advantages. The roundtrip times of downlink retransmissions are reduced. The distributed network functionalities are only performed for data block flows requiring it. Thus, the resources of the packet radio system are saved. Also, optimal base station operation is achieved.

### BRIEF DESCRIPTION OF THE DRAWINGS

In the following, the invention will be described in greater detail with reference to the preferred embodiments and the accompanying drawings, in which

FIG. 1 is a simplified block diagram illustrating the structure of a radio system;

FIG. 2 is another example illustrating the structure of a radio system;

FIG. 3 is a signal sequence diagram illustrating the method of controlling data transmission in a packet radio system, and

FIG. 4 is another signal sequence diagram illustrating an example of the method of controlling data transmission in a packet radio system.

### DETAILED DESCRIPTION OF THE PREFERRED EMBODIMENTS

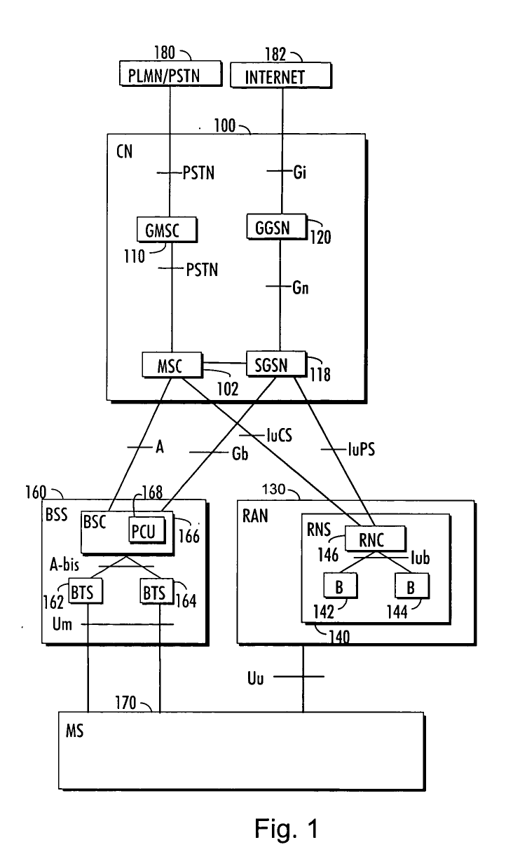

FIG. 1 is a simplified block diagram, which shows the most important parts of a radio system and the interfaces between them at network-element level. The main parts of a radio system are a core network (CN) 100, a radio access network 130 and user equipment (UE) 170. The radio access network 130 may be implemented by wideband code division multiple access (WCDMA) technology. The structure and functions of the network elements are not described in detail, because they are generally known.

A mobile services switching center (MSC) 102 is a mobile network element that can be used to serve the connections of both radio access network and a base station system 160. The tasks of the mobile services switching center 102 include: switching, paging, user equipment location registration, handover management, collection of subscriber billing information, encryption parameter management, frequency allocation management, and echo cancellation. The number of mobile services switching centers 102 may vary: a small network operator may only have one mobile services switching center 102, but in large core networks 100, there may be several.

Large core networks 100 may have a separate gateway mobile ser-vices switching center (GMSC) 110, which takes care of circuit-switched con-nections between the core network 100 and external networks 180. The gateway mobile services switching center 110 is located between the mobile ser-vices switching.center 102 and the external networks 180. An external network 180 can be for instance a public land mobile network (PLMN) or a public switched telephone network (PSTN).

A serving GPRS support node (SGSN) 118 is the center point of the packet-switched side of the core network 100. The main task of the serving GPRS support node 118 is to transmit and receive packets with mobile station 170 supporting packet-switched transmission by using the base station system 160. The serving GPRS support node 118 contains subscriber and location information related to the mobile station 170.

A gateway GPRS support node (GGSN) 120 is the packet-switched side counterpart to the gateway mobile services switching center of the circuit-switched side with the exception, however, that the gateway GPRS support node 120 is also capable of routing traffic from the core network 100 to external networks 182, whereas the gateway mobile services switching center only routes incoming traffic. In our example, the Internet represents external networks 182.

The base station system 160 comprises a base station controller (BSC) 166 and base transceiver stations (BTS) 162, 164. The base station controller 166 controls the base transceiver station 162, 164. Oftentimes the devices implementing the radio path and their functions reside in the base transceiver station 162, 164, and control devices reside in the base station controller 166.

The base station controller 166 takes care of the following tasks, for instance: radio resource management of the base transceiver station 162, 164, intercell handovers, frequency control, i.e. frequency allocation to the base transceiver stations 162, 164, management of frequency hopping sequences, time delay measurement on the uplink, implementation of the operation and maintenance interface, and power control.

A packet control unit (PCU) 168 is, for example, a chorusbased preprocessor computer in the base station controller 166. The packet control unit 168 may also be based on other operating systems than chorus. The packet control unit 168 may be connected to the base station controller signalling unit (BCSU) of the base station controller 166, for example. The base station controller 166 needs the packet control unit 168 for implementing both the Gb interface and RLC/MAC protocols in the base station subsystem 160. The RLC and the MAC protocols together form the OSI (Open System Interconnection) Layer 2 protocol for the Um interface. The packet control unit 168 may also reside in the base transceiver station 162, 164 or in the serving GPRS support node 118. For the sake of clarity, in the following examples the packet control unit 168 is however assumed to reside in the base station controller 166.

The base transceiver station 162, 164 contains at least one transceiver, which provides one carrier, i.e. eight time slots, i.e. eight physical channels. Typically, one base transceiver station 162, 164 serves one cell, but it is also possible to have a solution in which one base transceiver station 162, 164 serves several sectored cells. The tasks of the base transceiver station 162, 164 include: calculation of timing advance (TA), uplink measurements, channel coding, encryption, decryption, and frequency hopping.

The radio access network 130 is made up of radio network subsystems 140. Each radio network subsystem 140 is made up of radio network controllers 146 and B nodes 142, 144. A B node is a rather abstract concept, and often the term base transceiver station is used instead of it.

The mobile station 170 comprises at least one transceiver for establishing a radio link to the base station system 160. The mobile station 170 can contain different subscriber identity modules. In addition, the mobile station 170 contains an antenna, a user interface and a battery. Today, there are different types of mobile stations 170, for instance equipment installed in cars and portable equipment. Features better known from personal or portable computers have also been implemented in the mobile station 170.

In UMTS, the most important interfaces are the lu interface between the core network and the radio access network, which is divided into the interface luCS on the circuit-switched side and the interface luPS on the packet-switched side, and the Uu interface between the radio access network and the user equipment. In GSM/GPRS, the most important interfaces are the A interface between the base station controller and the mobile services switching center, the Gb interface between the base station controller and the serving GPRS support node, and the Um interface between the base transceiver station and the user equipment. The Um interface is the GPRS network interface for providing packet data services over the radio to the mobile station. The interface defines what kind of messages different network elements can use in communicating with each other.

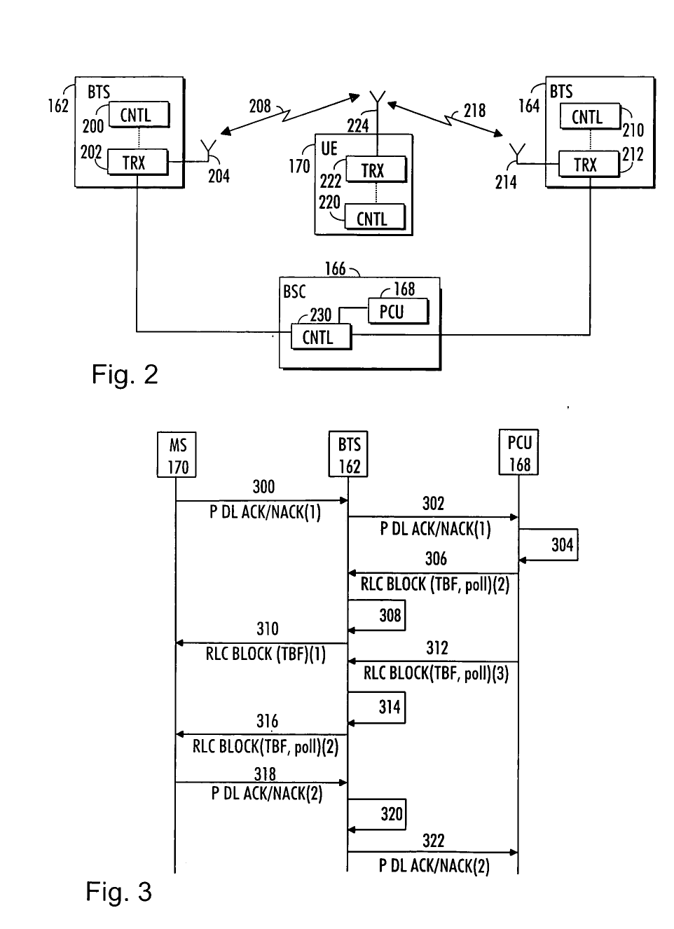

In the example of FIG. 2, the first base transceiver station 162 comprises a transceiver 202, an antenna 204 and a control unit 200. Similarly, the second base transceiver station 164 comprises a transceiver 212, an antenna 214 and a control unit 210. The base station controller 166 also comprises a control unit 230. The user equipment 170 also comprises a normal transceiver 222 and an antenna 224 for establishing a radio link 208, 218, and a control unit 220. The transceivers 202, 212, 222 may use TDMA technology, and for instance a normal GSM system GMSK (Gaussian Minimum Shift Keying) modulation or EDGE modulation, i.e. 8-PSK (8 Phase Shift Keying) modulation. The antennas 204, 214, 224 can be implemented by normal prior art, for instance as omni directional antennas or antennas using a directional antenna beam.

The control units 200, 210, 220, 230 refer to blocks controlling the operation of the device, which today are usually implemented using a processor with software, but different hardware implementations are also possible, such as a circuit made of separate logic components or one or more application-specific integrated circuits (ASIC). A combination of these methods is also possible.

Different radio block structures for data transfer and control message transfer purposes are defined. The radio block structure for data transfer is different for GPRS and EGPRS radio systems, whereas the same radio block structure is used for control messages.

Radio blocks for data transfer may comprise MAC (Medium Access Control) headers, RLC (Radio Link Control) headers, RLC/MAC headers, RLC data blocks, and RLC/MAC control messages. The data blocks may be carried by normal bursts. The different headers comprise control fields, which are different for uplink and downlink directions. The Medium Access Control (MAC) and Radio Link Control (RLC) layer operates above the Physical Link layer in the reference architecture.

The MAC function defines the procedures that enable multiple mobile stations to share a common transmission medium, which may consist of several physical channels. The MAC function provides arbitration between multiple mobile stations attempting to transmit simultaneously and provides collision avoidance, detection and recovery procedures. The RLC function defines the procedures for a bitmap selective retransmission of unsuccessfully delivered RLC data blocks. The RCL UMAC function provides an unacknowledged operation and an acknowledged operation.

The GPRS radio interface comprises independent uplink and downlink channels. The downlink carries transmissions from the network to multiple mobile stations, and the uplink is shared among multiple mobile stations for transmissions in which the mobile station transmits and the base transceiver station receives. Multiplexing the RLC/MAC blocks for different mobile stations on the same downlink channel is enabled by an identifier, for example, a temporary flow identity (TFI), included in each RLC/MAC block. The network sends the RLC/MAC blocks belonging to one temporary block flow on downlink on the assigned downlink channels.

After the mobile station has sent its last RLC data block, an acknowledgement message is expected from the network side. By sending the last block, the mobile stations may no longer use the same assignment unless a negative acknowledgement arrives. It also means that the network side may reallocate the same USF(s) (uplink state flags) to some other user as soon as all the RLC data blocks belonging to the certain temporary block flow are correctly received and the uplink temporary block flow has been released. Packet uplink ACK/NACK messages or response packet control ACKs may be lost leading to retransmissions. Thus, the packet control unit has to keep ids (USF, TFI) reserved until the packet control unit is sure that the mobile station is no longer using uplink temporary block flow resources. If all RLC data blocks have been correctly received, the network sends packet uplink ACK (positive acknowledgement)/NACK (negative acknowledgement), which is to be immediately acknowledged by the mobile stations in the reserved uplink block period.

The sending of the packet downlink ACK/NACK message is obtained by the occasional network initiated polling of the mobile stations. The mobile station sends the packet downlink ACK/NACK message in a reserved radio block, which is allocated together with polling. Further, if the mobile station needs to send some additional signalling or uplink data, it may be indicated in the packet downlink ACK/NACK message.

In (E)GPRS there exists an ability to retransmit a packet data block that has not been decoded properly with a more robust coding scheme. Once packets have been sent, they must be retransmitted using the original coding scheme even if the radio environment has changed.

For example, the mobile station receives data from the network on the downlink. Based on GPRS measurement report that was previously received, the link adaptation algorithm in the base station controller decides to send the next data blocks. During the transmission of these packages, the carrier-to-interference ratio decreases dramatically, changing the radio environment. After the packets have been transmitted, the network polls for a new measurement report, including the ACK/NACK bitmap that tells the network work which data blocks were received correctly. The mobile station replies with a packet downlink ACK/NACK message containing the information about the link quality and the bitmap. On the basis of the new link quality information the GPRS link adaptation algorithm will adapt the coding scheme to the new radio environment. Because GPRS cannot resegment, the old packets must be retransmitted.

The transfer of RLC data blocks in the acknowledged RLC/MAC mode is controlled by a selective ARQ (Automatic Repeat request) mechanism coupled with the numbering of the RLC data blocks within one temporary block flow (TBF). The sending side (the mobile station or the network) transmits blocks within a window and the receiving side sends a packet uplink ACK/NACK or a packet downlink ACK/NACK message when needed. Every such message acknowledges all correctly received RLC data blocks up to an indicated block sequence number (BSN), thus “moving” the beginning of the sending window on the sending side. Additionally, the bitmap that starts at the same RLC data block is used to selectively request erroneously received RLC data blocks for retransmission. The sending side then retransmits the erroneous RLC data blocks, eventually resulting in further sliding the sending window. When receiving uplink data from a mobile station the network may, on the basis of erroneous blocks received from the mobile station, allocate additional resources for retransmission.

The transfer of RLC data blocks in the acknowledged RLC/MAC mode can be controlled by a selective type I ARQ mechanism, or by type II hybrid ARQ (incremental redundancy: IR) mechanism, coupled with the numbering of the RLC data blocks within one temporary block flow. The sending side transmits blocks within a window and the receiving side sends a packet uplink ACK/NACK or a packet downlink ACK/NACK message when needed. According to the link quality, an initial MCS is selected for an RLC block. For the retransmissions, the same or another MCS from the same family of MCSs can be selected. The network controls the selection of MCS.

In the EGPRS type II Hybrid ARQ scheme, the information is first sent at one of the initial code rates, that is, the rate ⅓ encoded data is punctured with the puncturing scheme (PS) 1 of the selected MCS. If the RLC data block is received in error, additional coded bits, that is, the output of the rate ⅓ encoded data which is punctured with PS 2 of the prevailing MCS are sent and decoded together with the already received code words until decoding succeeds. If all the code words, for example, different punctured versions of the encoded data block, have been sent, the first codeword is sent. It is also possible to use incremental redundancy modes called MCS-5-7 and MCS-6-9, in which the initial transmissions are sent with either MCS-5 or MCS-6 and the retransmissions are sent with MCS-7 or MCS-9.

In an embodiment of the invention, the packet control unit 168 is configured to determine which given packet control unit functionalities related to transmission of given control or data blocks are to be distributed from the packet control unit 168 to a remote network element, and to provide to the remote network element control information on which packet control unit functionalities are distributed to the remote network element. The remote network element in turn is configured to perform the given packet control unit functionalities for given control or data blocks on the basis of the control information received from the packet control unit 168.

The above remote network element can be a base transceiver station 162, 164 or a base station controller 166. From hereon, for the sake of simplicity, the following examples describe situations where the remote network element is a base station 162, 164 and the packet control unit 168 resides in the base station controller 166. However, the following embodiments are feasible also when the remote network element is a base station controller 166 instead of the base station 162, 164, and when the packet control unit 168 resides in the base station 162, 164.

The control information is provided to the base station 162, 164 for telling to which block flows (TBFs) a certain base station activity, like distributed retransmission scenario or uplink sending permission replacement, is enabled. Thus, the control information enables base station flow operations only for flows really requiring the operations to be performed. For other flows the base station 162, 164 operates as currently, that is, transfers bits between Um and Abis not interpreting the contents of the RLC/MAC blocks. By controlling the base station 162, 164 operation and telling to the base station 162, 164 which flows are considered more important than the others, the base station 162, 164 power is saved and also RLC/MAC may be working more efficiently on Um interface. The radio resources are not wasted for flows not needing “special care”.

The packet control unit 168, base station 162, 164 or other device or the radio system may decide, on the basis of quality of service (QoS) or other information related to flow transferring messages between the mobile station 162, 164 and the network, whether the flow has certain characteristics requiring a base station 162, 164 to take part in flow handling and message transfer. For example, some flows may have strict delay requirements requiring that base station 162,164 enables downlink RLC data block retransmission from the base station 162, 164. Other flows may not have that strict delay requirements meaning that it is enough if the packet control unit 168 retransmits downlink RLC data blocks.

The control information controlling which activities will be enabled for a flow may be transferred to base station 162, 164 on packet control unit TRAU (transcoding and rate adaptation unit) frames used on Abis interface. Also, other messages can be used for this. On the basis of the received control information, the base station 162, 164 is able to enable or disable some distributed functionalities, like RLC/MAC functionalities, for given flows.

It is possible that the control information telling which packet control unit functionalities are distributed between base station 162, 164 and the packet control unit 168 is communicated using an offline signalling beforehand. Such a signalling may be performed by using packet control unit TRAU frame control bits that are not transferring RLC/MAC blocks for the given mobile station, for example. The TRAU frames may be transferred between the base station and the packet control unit every 20 ms for every radio channel allocated for GPRS, and thus the TRAU frame carrying distributed functionality control information may transfer RLC/MAC blocks to a given mobile station, transfer RLC/MAC blocks to different mobile stations or may be idle, that is, not containing RLC/MAC block.

In an embodiment, the packet control unit 168 provides the base station 162, 164 control information telling online if the base station 162, 164 may enable the given packet control unit functionalities. For example, the packet control unit 168 may inform the base station 162, 164 to manipulate the packet uplink ACK/NACK bitmap in the same packet control unit TRAU frame transferring packet uplink ACK/NACK message. It is also possible that the packet control unit 168 tells the base station 162, 168 beforehand that a given functionality is activated, and then the base station 162, 164 may e.g. manipulate every packet uplink ACK/NACK bitmap sent to a particular mobile station without additional signalling from the packet control unit 168. The base station 162, 164 functionalities may also be turned off any time by the packet control unit 168.

In an embodiment, the base station 162, 164 may determine that it is advantageous to perform some functionalities based on radio condition, for example. The decision to enable a given packet control unit functionality may be based on the control information received from the packet control unit 168 earlier. The base station 162, 164 may then signal the packet control unit 168 when a given functionality is enabled, and the packet control unit 168 may then modify its operation based on the base station 162, 164 functionality and operations. Thus, the enabling and the disabling the packet control unit functionalities in the base station 162, 164 may be controlled by the packet control unit 168 and/or the base station 162, 164.

In another embodiment, the base station 162, 164 may monitor the Um interface, for example, and based on the quality of the Um interface the base station 162, 164 may then determined that a given flow requires special handling. Thus, the base station 162, 164 may enable a given distributed packet control unit functionality, and notify the packet control unit 168 about it. This would optimise the radio channel usage and/or flow usage. The enabling of the given distributed packet control unit functionalities may then be decided by both the packet control unit 168 and the base station 162, 164 either to optimise a flow or an Um behaviour, for example.

The packet control unit 168 or the base station 162, 164 may decide on the basis of QoS information if distributed functionalities related to transmission of given control data blocks, such as RLC/MAC functionalities, shall be enabled between the packet control unit 168 and the base station 162, 164 for given blocks. QoS information may be received from a serving GPRS support node 118 or from a mobile station 170. In case some distributed functionalities shall be enabled or disabled between the packet control unit 168 and the base station 162, 164, the packet control unit 168 notifies the base station 162, 164 via Abis using packet control unit TRAU frame control bits. The base station 162, 164 then operates according to the control information received from the packet control unit 168 via Abis interface. For example, packet control unit TRAU frames contain bit for each distributed functionality and, on the basis of bit position (0/1), the base station 162, 164 can enable or disable a given functionality.

In an embodiment, the base station 162, 164 may manipulate ACK/NACK messages received from the packet control unit 168 on the basis of the control information from the packet control unit 168. The base station 162, 164 may, for example, manipulate the uplink ACK/NACK messages according to RLC block state on the base station 162, 164. It is possible that the base station 162, 164 reuses an uplink Incremental Redundancy mechanism already handling the uplink RLC blocks when manipulating the ACK/NACK messages. A base station countdown value maximum (BS_CV_MAX) may be reduced according to reduced roundtrip time (RTT). The roundtrip time is the time delay between the sending and acknowledgement of a packet. If the roundtrip time is too short or too long, messages may be retransmitted needlessly. The base station countdown value maximum is reduced from 9 to 3, for example.

In an embodiment, the base station 162, 164 modifies an ACK bit map of the uplink ACK message sent from the packet control unit 168 to represent the latest situation in the base station 162, 164. It is also possible, that the packet control unit 168 commands the base station 162, 164 to discard earlier sent NACKed uplink RLC blocks in order to enable the uplink ACK window to move on.

In another embodiment, the base station 162, 164 generates ACK/NACK messages and replaces the downlink RLC data blocks by the generated uplink ACK/NACK messages according to the control information from the packet control unit 168. The base station 162, 164 replaces the RLC blocks by the uplink ACK/NACK messages generated in the base station 162, 164 when allowed by the packet control unit 168 and the uplink ACK/NACK sending conditions are met. For example, the mobile station 170 has to retransmit some uplink blocks when the last uplink block is indicated.

In an embodiment, the base station 162, 164 may perform downlink retransmission, which is normally performed by the packet control unit 168, based on the control information from the packet control unit 168. The downlink retransmission may be performed according to decoded (=spied) downlink ACK/NACK messages. The base station 162, 164 may reuse a Pointer Retransmission over Abis mechanism that already stores downlink blocks to the base station 162, 164 for performing the downlink retransmission. The base station 162, 164 decodes a downlink ACK message bit map from the mobile station 170 and retransmits NACKed blocks when the packet control unit 168 has allocated the turn for particular block flow, for example. The base station 162, 164 may use a normal priority order for RLC downlink transmissions wherein the order is the following: retransmissions, new blocks and pending blocks. The base station 162, 164 may select the puncturing scheme and/or modulation-coding scheme for retransmission with existing rules of the packet control unit 168. However, the packet control unit 168 may still perform retransmissions for example in case of reallocation to new TRX or in case of resegmentation. The overall retransmission control stays on the packet control unit 168, which can for example reset the retransmission memory for each temporary block flow. When retransmitting the downlink data block the base station may notify the packet control unit about it. The packet control unit may then utilize this information in its downlink retransmission algorithm.

In an embodiment, the base station 162, 164 performs downlink polling on the basis of the control information received from the packet control unit 168. The packet control unit 168 allows the base station 162, 164 to perform polling by setting poll_ena per transmitted RLC block, for example. The base station 162, 164 may thus set the polling bit, if the polling conditions are met, that is, the current block is the last block, for example. It is also possible that If the base station 162, 164 can set an uplink state flag (USF), the base station 162, 164 “reserves” the USF for polling response at appropriate time, for example at +60 ms.

Let us next study the example of FIG. 3 of a data transmission controlling method. In FIG. 3, the first vertical line MS 170 denotes communication originating from and terminating in a mobile station. The second vertical line BTS 162 denotes communication of a base station and measures taken by the base station. The third vertical line PCU 168 denotes communication of the packet control unit and measures taken in the packet control unit.

The example of FIG. 3 illustrates the method in downlink situation. Control and data blocks are communicated between the mobile station, the packet control unit and the base station. The control blocks are for controlling the data transmission in the radio system.

As an overview, in 304, it is determined, by the packet control unit, which given packet control unit functionalities related to transmission of given control data blocks are to be distributed from the packet control unit to the base station. In 306, the packet control unit provides to the base station, control information on which packet control unit functionalities are distributed to the base station. The control information may be provided with an RLC block transmitted from the packet control unit to the base station. However, it is also possible that also the base station may determine which given packet control unit functionalities are enabled to be performed, and then the base station may send a notification to the packet control unit about which given packet control unit functionalities are enabled by the base station. The packet control unit may then adjust its own activities based on the notification. The base station may determine which functionalities are enabled itself or based on information received from the packet control unit. Thus, it is possible that the packet control unit and the base station both control the enabling of a given distributed functionality. The steps from 308 to 322 describe examples of the packet control unit functionalities performed by the base station for given control data blocks on the basis of the control information received from the packet control unit.

In 300, the first packet downlink ACK/NACK message is sent from the mobile station to the base station. In 302, the base station further transmits the first packet downlink ACK/NACK message unchanged to the packet control unit. The packet control unit may determine, in 304, which packet control unit functionalities related to transmission of given control data blocks are to be distributed from the packet control unit to the base station based on messages received by the packet control unit, for example. The messages received by the packet control unit comprise flow-transferring messages between the mobile station and the packet radio system, for example, or quality of service messages received from the mobile station or from a serving general packet radio service support node. It is possible, that the packet control unit determines, in 304, whether there is a need to distribute any packet control unit functionalities related to transmission of given control data blocks based on the information comprised in the first packet downlink ACK/NACK message, for example.

In 306, the second RLC block is sent from the packet control unit to the base station. In an embodiment, in 308, the base station decodes the downlink ACK/NACK messages received from the mobile station and detects whether there exists NACKed RLC blocks for the same temporary block flow in the base station buffer, and that being the case, the RLC block is replaced by the oldest NACked block. The base station may also select the puncturing and modulation coding schemes for the retransmission of the negative acknowledgement messages.

In 310, the first NACKed RLC block is retransmitted to the mobile station thus enabling achieving about 100 ms faster downlink retransmission times. In 312, the third RLC block is received in the base station from the packet control unit. The base station keeps track of the received RLC blocks in 314, and sends the second RLC block to the mobile station in 316. In 318, the second packet downlink ACK/NACK message is received in the base station, and, in 320, the status of the downlink blocks are changed to be acknowledged in the base station retransmission buffer. Finally, in 322, the second downlink ACK/NACK message is sent to the packet control unit.

In another embodiment, the step of performing the packet control unit functionalities comprises also performing polling by the base station. In that case, in 306, the packet control unit sends control information enabling the base station to perform polling. In 308, the base station decodes the downlink ACK/NACK messages received from the mobile station and detects whether there exists NACKed RLC blocks for the same temporary block flow in the base station buffer, and that being the case, the RLC block is replaced to the oldest NACked block. Then the base station selects the puncturing and modulation coding schemes for the retransmission of the negative acknowledgement messages. Further, if the RLC block to be sent is the last block and polling is allowed by the packet control unit, then the base station sets a polling bit and reserves an uplink state flag for polling response. Thus, about 100 ms faster polling of last block is enabled. The base station based polling may also be enabled in the middle of a data block transmission in order to quickly determine whether the mobile station has received a downlink RLC data block or not, and in order to enable the fastest response times possible.

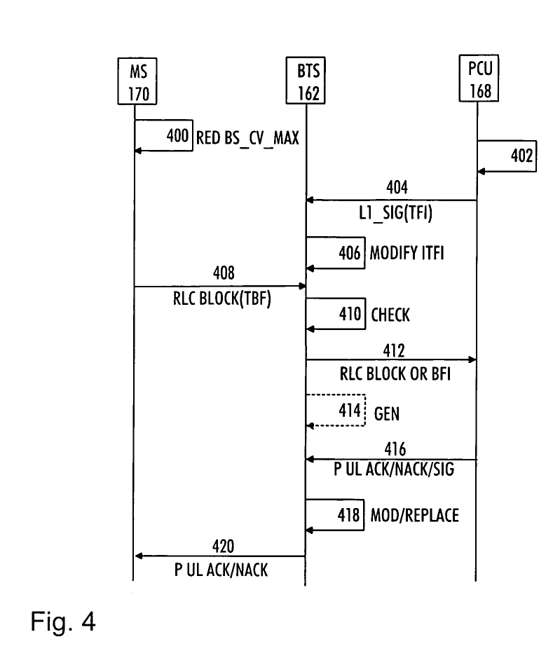

Next, let us study an example of FIG. 4 of a data transmission controlling method. In FIG. 4, the first vertical line MS 170 denotes communication originating from and terminating in a mobile station. The second vertical line BTS 162 denotes communication of a base station and measures taken by the base station. The third vertical line PCU 168 denotes communication of the packet control unit and measures taken in the packet control unit. The dashed lines in FIG. 4 illustrate alternative steps of the method.

The example of FIG. 4 illustrates the method in uplink situation. In 400, the control data blocks transmitted between the mobile station, the base station and the packet control unit comprise uplink ACK/NACK messages, and the step of performing the given packet control unit functionalities comprises generating or manipulating the uplink ACK/NACK messages.

In 400, the mobile station reduces the base station count down value maximum from 9 to 3 on the basis of its knowledge of the roundtrip time of the network. In 402, it is determined, by the packet control unit, which given packet control unit functionalities related to transmission of given control data blocks are to be distributed from the packet control unit to the base station. In 404, the packet control unit provides the base station, with control information on which packet control unit functionalities are distributed to the base station. The control information may be included in a L1 layer signalling message, for example. Also, internal temporary flow identity information (I TFI) is transmitted to the base station. The internal temporary flow identity information is needed in the uplink method for enabling the base station to connect the received data blocks.

In 406, the base station modifies the internal temporary flow identity information table. In 408, an uplink RLC block is received in the base station, and in 410, the base station detects whether the received uplink RLC block is valid. The validity of the uplink RLC block may be checked by using the sum of CRC (Cyclic Redundancy Check), for example. If the uplink RLC block is valid, then in 412, the uplink RLC block is sent to the packet control unit and the actual block is set ACKed. However, if the uplink RLC block is invalid, then a bad frame indicator (BFI) is sent to the packet control unit and an actual backward sequence number (BSN) is set NACKed.

In 416, the packet uplink ACK/NACK message is received in the base station from the packet control unit. In 418, the ACK bit map in received the packet uplink ACK message is modified according to the latest status in the base station. The ACK bit map is modified such that the current state of the base station may be interpreted from it. Finally, in 420, a packet uplink ACK/NACK message is sent to the mobile station from the base station according to the modified ACK bit map. This embodiment enables between 100 ms to 300 ms faster NACK time depending on ACK period.

In another embodiment illustrated with the dashed line in 414, an uplink ACK/NACK message is generated in the base station, if the last control data block is concerned. The packet control unit may give the base station a permission to generate the uplink ACK/NACK message. The base station first detects whether the last block is concerned and that being the case, the uplink ACK/NACK message may be generated. In 416, the packet control unit sends control information comprising the uplink ACK message generation enablement. In 418, the base station replaces a possible downlink data block received from the packet control unit by the generated uplink ACK/NACK message according to the received control information from the packet control unit. In 420, the replaced generated packet uplink ACK/NACK message is sent to the mobile station. This embodiment may enable between 160 ms to 200 ms faster NACK time.

Even though the invention is described above with reference to an example according to the accompanying drawings, it is clear that the invention is not restricted thereto but it can be modified in several ways within the scope of the appended claims.

1. A method of controlling data transmission in a radio system, the method comprising:
communicating control blocks and data blocks between a mobile station, a packet control unit and a remote network element, the control blocks controlling data transmission;
determining, by the packet control unit, which given packet control unit functionalities related to the transmission of given control blocks or data blocks are to be distributed from the packet control unit to a remote network element;
providing to the remote network element, by the packet control unit, control information on which packet control unit functionalities are distributed to the remote network element; and
performing, by the remote network element, the packet control unit functionalities for given control blocks or data blocks on the basis of the control information received from the packet control unit.

2. The method of claim 1, wherein the remote network element is a base station controller or a base transceiver station of the radio system.

3. The method of claim 1, the method further comprising determining, by the remote network element, which given distributed functionalities are enabled to be performed.

4. The method of claim 3, the method further comprising sending notification to the packet control unit about which given distributed functionalities are enabled by the remote network element.

5. The method of claim 1, wherein the control blocks and data blocks comprise uplink positive acknowledgement or negative acknowledgement messages, and the step of performing the given packet control unit functionalities comprises generating or manipulating the uplink positive acknowledgement or negative acknowledgement messages.

6. The method of claim 5, wherein the step of manipulating uplink positive acknowledgement or negative acknowledgement messages comprises:
determining the validity of the received control data blocks;
setting a data block acknowledged and forwarding the data block to the packet control unit, when the data block received from the mobile station is valid;
setting an actual block sequence number negatively acknowledged, when the data block received from the mobile station is invalid; and
modifying an acknowledged bit map of the acknowledgement message received from the packet control unit on the basis of the latest data block status of the remote network element.

7. The method of claim 5, the method further comprising replacing the received control block or data block by the generated uplink positive acknowledgement or the negative acknowledgement message, when allowed by the packet control unit according to the received control information.

8. The method of claim 6, the method further comprising:
managing different uplink temporary flows by the remote network element on the basis of the information received from the packet control unit;
determining, by the remote network element, the validity of the received control data blocks;
setting a data block acknowledged and forwarding the data block to the packet control unit, when the data block received from the mobile station is valid;
setting an actual block sequence number negatively acknowledged, when the data block received from the mobile station is invalid;
generating an uplink positive acknowledgement or negative acknowledgement message, when the last data block is received; and
replacing the data block received from the packet control unit by the uplink positive acknowledgement or negative acknowledgement message.

9. The method of claim 1, wherein the control information between the packet control unit and the remote network element is sent within control blocks or data blocks or by using a separate message.

10. The method of claim 1, wherein the control data blocks comprise uplink positive acknowledgement or negative acknowledgement messages, and the step of performing the given packet control unit functionalities comprises discarding earlier negatively acknowledged uplink data blocks for enabling an uplink acknowledgement window to move on, based on the received control information from the packet control unit.

11. The method of claim 1, wherein the control data blocks comprise downlink positive acknowledgement or negative acknowledgement messages, and the step of performing the given packet control unit functionalities comprising decoding downlink acknowledgement messages received from a mobile station, and retransmitting negatively acknowledged data blocks.

12. The method of claim 11, the method further comprising selecting puncturing and modulation coding schemes for the retransmission of the negative acknowledged data blocks.

13. The method of claim 11, the method further comprising replacing a data block by the oldest negatively acknowledged data block, when there are negatively acknowledged data blocks for the same temporary block flow in a remote network element buffer, and changing status of the downlink data blocks to acknowledged in a remote network element retransmission buffer according to downlink packet acknowledgement messages received from the mobile station.

14. The method of claim 1, wherein the step of performing the packet control unit functionalities comprises performing polling by the remote network element.

15. The method of claim 14, the method further comprising setting a polling bit, when predetermined polling conditions are met.

16. The method of claim 1, wherein determining which packet control unit functionalities related to transmission of given control blocks or data blocks are to be distributed from packet control unit to a remote network element is based on messages received from the packet control unit.

17. The method of claim 16, wherein the messages received by the packet control unit comprise flow transferring messages between the mobile station and the packet radio system or quality of service messages received from the mobile station or from a serving general packet radio service support node.

18. The method of claim 1, wherein the control blocks or data blocks comprise radio link control, RLC/medium access control, MAC, data blocks.

19. A method of controlling data transmission in a radio system, the method comprising:
communicating control blocks and data blocks between a mobile station and a packet control unit via a remote network element, the control blocks controlling data transmission and comprising uplink positive acknowledgement or negative acknowledgement messages;
determining which given packet control unit functionalities related to the transmission of given control or data blocks are to be distributed from the packet control unit to a remote network element; and
generating or manipulating, by the remote network element, the uplink positive acknowledgement or negative acknowledgement messages on the basis of the determination.

20. The method of claim 18, wherein the step of manipulating comprises modifying an acknowledgement bit map of the uplink acknowledgement message received from the packet control unit on the basis of the latest status of the data blocks on the remote network element.

21. The method of claim 18, the method further comprising replacing the data block by the generated uplink positive acknowledgement or negative acknowledgement message, when allowed by the packet control unit according to the received control information.

22. A method of controlling data transmission in a radio system, the method comprising:
communicating control blocks and data blocks between a mobile station, a packet control unit and a remote network element, the control blocks controlling data transmission and comprising downlink positive acknowledgement or negative acknowledgement messages;
determining which given packet control unit functionalities related to the transmission of given control or data blocks are to be distributed from the packet control unit to a remote network element; and
decoding, by the remote network element, the downlink acknowledgement messages received from the mobile station, and retransmitting negative acknowledged data blocks, on the basis of the determination.

23. A radio system comprising a remote network element, a packet control unit and a mobile station, the radio system being configured to communicate control blocks and data blocks between the mobile station, the packet control unit and the remote network element, the control blocks controlling data transmission in the radio system, wherein:
the packet control unit is configured to determine which given packet control unit functionalities related to the transmission of given control or data blocks are to be distributed from the packet control unit to a remote network element, and to provide to the remote network element control information on which packet control unit functionalities are distributed to the remote network element; and
the remote network element is configured to perform the given packet control unit functionalities for given control blocks or data blocks on the basis of the control information received from the packet control unit.

24. The radio system of claim 23, wherein the remote network element is a base station controller or a base transceiver station of the radio system.

25. The radio system of claim 23, wherein the remote network element is further configured to determine which given distributed functionalities are enabled to be performed.

26. The radio system of claim 25, wherein the remote network element is further configured to send notification to the packet control unit about which given distributed functionalities are enabled by the remote network element.

27. The radio system of claim 23, wherein the control blocks and data blocks comprise uplink positive acknowledgement or negative acknowledgement messages, and the remote network element is configured to generate or manipulate the uplink positive acknowledgement or negative acknowledgement messages, when performing the given packet control unit functionalities.

28. The radio system of claim 27, wherein when manipulating the uplink positive acknowledgement or negative acknowledgement messages the remote network element is configured to:
determine the validity of the received data blocks;
set a data block acknowledged and forward the data block to the packet control unit, when the data block received from the mobile station is valid;
set an actual block sequence number negatively acknowledged, when the data block received from the mobile station is invalid; and
modify an acknowledged bit map of an acknowledgement message received from the packet control unit on the basis of the latest status of the data blocks on the remote network element.

29. The radio system of claim 27, wherein the remote network element is configured to replace the received data block by the generated uplink positive acknowledgement or the negative acknowledgement message, when allowed by the packet control unit according to the received control information.

30. The radio system of claim 23, wherein the control blocks and data blocks comprise downlink positive acknowledgement or negative acknowledgement messages, and the remote network element is configured to decode the downlink acknowledgement messages received from a mobile station, and retransmit the negative acknowledgement messages.

31. A radio system comprising a remote network element, a packet control unit and a mobile station, the radio system being configured to communicate control blocks and data blocks between the mobile station, the packet control unit and the remote network element, the control blocks and data blocks controlling data transmission and comprising uplink positive acknowledgement or negative acknowledgement messages, wherein:
the packet control unit or a remote network element is configured to determine which given packet control unit functionalities related to the transmission of given control data blocks are to be distributed from the packet control unit to the remote network element; and
the remote network element is configured to generate or manipulate the uplink positive acknowledgement or negative acknowledgement messages on the basis of the determination by the packet control unit or by the remote network element.

32. A radio system comprising a remote network element, a packet control unit and a mobile station, the radio system being configured to communicate control blocks and data blocks between the mobile station, the packet control unit and the remote network element, the control blocks controlling data transmission and comprising downlink positive acknowledgement or negative acknowledgement messages, wherein:
the packet control unit or a remote network element is configured to determine which given packet control unit functionalities related to the transmission of given control data blocks are to be distributed from the packet control unit to the remote network element; and
the remote network element is configured to decode the downlink acknowledgement messages received from the mobile station, and to retransmit negative acknowledgement messages, on the basis of the determination by the packet control unit or by the remote network element.

33. A packet control unit of a radio system, the packet control unit comprising one or more communication units for communicating control blocks and data blocks with a remote network element, and a control unit for controlling the functions of the packet control unit, wherein:
the control unit is further configured to determine which given packet control unit functionalities related to the transmission of given control blocks or data blocks are to be distributed from packet control unit to the remote network element; and
the communication unit is configured to provide to the remote network element control information on which packet control unit functionalities are distributed to the remote network element.

34. A remote network element of a radio system, the remote network element comprising one or more transceivers for communicating control blocks and data blocks with a packet control unit and a mobile station, and a control unit for controlling the functions of the remote network element, wherein:
the transceiver is further configured to receive from the packet control unit control information on which given packet control unit functionalities are distributed to the remote network element; and
the control unit is configured to perform the packet control unit functionalities for given control blocks or data blocks based on the control information received from the packet control unit.

35. The remote network element of claim 34, wherein the remote network element is a base station controller or a base transceiver station of the radio system.

36. The remote network element of claim 34, the remote network element is further configured to determine which given distributed functionalities are enabled to be performed.

37. The remote network element of claim 34, wherein the control blocks and data blocks comprise uplink positive acknowledgement or negative acknowledgement messages, and the remote network element is configured to generate or manipulate the uplink positive acknowledgement or negative acknowledgement messages, when performing the given packet control unit functionalities.

38. The remote network element of claim 34, wherein the control blocks and data blocks comprise downlink positive acknowledgement or negative acknowledgement messages, and the remote network element is configured to decode the downlink acknowledgement messages received from a mobile station, and to retransmit the negative acknowledgement messages.

39. A base transceiver station of a radio system, the base transceiver station comprising one or more transceivers for communicating control blocks and data blocks with a packet control unit and a mobile station, and a control unit for controlling the functions of the base transceiver station, wherein:
the transceiver is further configured to receive from the packet control unit control information on which given packet control unit functionalities are distributed to the base transceiver station; and
the control unit is configured to perform the packet control unit functionalities for given control blocks or data blocks based on the control information received from the packet control unit.

40. A base station controller of a radio system, the base station controller comprising one or more transceivers for communicating control blocks and data blocks with a packet control unit and a mobile station, and a control unit for controlling the functions of the base station controller, wherein:
the transceiver is further configured to receive from the packet control unit control information on which given packet control unit functionalities are distributed to the base station controller; and
the control unit is configured to perform the packet control unit functionalities for given control blocks or data blocks based on the control information received from the packet control unit.

41. A radio system comprising a remote network element, a packet control unit and a mobile station, the remote network element comprising means for communicating control blocks and data blocks with the packet control unit and the mobile station, the control blocks controlling data transmission in the radio system,
the packet control unit comprising means for determining which given packet control unit functionalities related to the transmission of given control blocks or data blocks are to be distributed from the packet control unit to the remote network element, and for providing to the remote network element control information on which packet control unit functionalities are distributed to the remote network element; and
the remote network element further comprising means for performing the packet control unit functionalities for given control blocks or data blocks on the basis of the control information received from the packet control unit.
